(19) United States
(12) Patent Application Publication
(10) Pub. No.: US 2008/0204685 A1
(43) Pub. Date: Aug. 28, 2008

(54) EXPOSURE APPARATUS, EXPOSURE METHOD AND LITHOGRAPHY SYSTEM

(76) Inventors: Takuya KONO, Yokosuka-shi (JP); Tatsuhiko Higashiki, Fujisawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/035,217

(22) Filed: Feb. 21, 2008

(30) Foreign Application Priority Data
Feb. 23, 2007 (JP) 2007-044163

(51) Int. Cl. G03B 27/42; G03B 27/54; G03B 27/70

(52) U.S. Cl. 355/53; 355/77; 355/67; 355/66

(57) ABSTRACT

An exposure apparatus includes a first exposure apparatus used for exposing a peripheral portion of a wafer in maskless manner, the first exposure apparatus including a light source configured to emit light, a stage on which the wafer is to be placed, and a light controller configured to control the light emitted from the light source and irradiated onto a peripheral portion of the wafer placed on the stage, the light controller controlling at least one of shape, size and coverage on the wafer of the light emitted from the light source.

### CROSS-REFERENCE TO RELATED APPLICATIONS

This application is based upon and claims the benefit of priority from prior Japanese Patent Application No. 2007-044163, filed Feb. 23, 2007, the entire contents of which are incorporated herein by reference.

### BACKGROUND OF THE INVENTION

1. Field of the Invention

The present invention relates to an exposure apparatus, an exposure method and a lithography system, used for manufacturing a semiconductor device.

2. Description of the Related Art

Conventionally, a semiconductor circuit is formed by repeating a step of forming an insulating film, semiconductor film or conductive film on a semiconductor substrate, a step of processing the insulating film, the semiconductor film or the conductive film (hereinafter, referred to simply as film) to a desired shape.

The step of processing the film into the desired shape includes a step of forming a resist pattern on the processed film (photolithography process), and a step of etching the processed film using the resist pattern as a mask (etching process).

The photolithography process includes a step of applying resist on a wafer (application step), a step of exposing the resist (exposure process), and a step of developing the exposed resist (development process).

The exposure process is carried out using an exposure apparatus. At this time, as shown in FIG. 6, a shot area (exposure area) 82 of peripheral portion of a wafer 81 includes an area protruding from the wafer 81. The exposure (peripheral exposure) of the shot area including the area protruding from the wafer 81 as described above is called deficient shot.

If the deficient shot is not carried out, the coverage of the wafer peripheral portion is different from that of the wafer center portion and in the etching process performed after the lithography process, the dimensional uniformity in the wafer plane is reduced. As a result, it is difficult to control dimensional uniformity in the wafer plane.

On the other hand, there has been proposed a method of carrying out exposure using reticle blind variable (e.g., see Jpn. Pat. Appln. KOKAI Publication No. 2006-278820). By using this exposure method, a shot size of the peripheral exposure is made small so that the shot area does not protrude from the wafer.

However, since the reticle blind variable is needed to be incorporate into the exposure apparatus at the time of wafer exposure, there arises a problem that throughput is largely reduced.

### BRIEF SUMMARY OF THE INVENTION

According to an aspect of the present invention, there is provided an exposure apparatus including a first exposure apparatus used for exposing a peripheral portion of a wafer in maskless manner, the first exposure apparatus comprising: a light source configured to emit light; a stage on which the wafer is to be placed; and a light controller configured to control the light emitted from the light source and irradiated onto a peripheral portion of the wafer placed on the stage, the light controller controlling at least one of shape, size and coverage on the wafer of the light emitted from the light source.

According to an aspect of the present invention, there is provided an exposure method including exposing a peripheral portion of a wafer in maskless manner, comprising: and controlling at least one of shape, size and coverage on the wafer of the light emitted from the light source, while exposing the peripheral portion of the wafer.

According to an aspect of the present invention, there is provided a lithography system comprising: an application equipment configured to apply resist on a wafer;

an exposure apparatus configured to expose a peripheral portion and a portion other than the peripheral portion of the resist applied on the wafer by the application equipment, the exposure apparatus including a first exposure apparatus configured to expose the peripheral portion of the resist in maskless manner and a second exposure apparatus configured to expose the portion other than the peripheral portion of the resist, the first exposure apparatus comprising a light source configured to emit light; a stage on which the wafer is to be placed; and a light controller configured to control the light emitted from the light source and irradiated onto the peripheral portion of the wafer placed on the stage, the light controller controlling at least one of shape, size and coverage on the wafer of the light emitted from the light source; and a developing equipment configured to develop the peripheral portion and the portion other than the peripheral portion of the resist exposed by the exposure apparatus.

### BRIEF DESCRIPTION OF THE SEVERAL VIEWS OF THE DRAWING

FIG. 1 is a flowchart showing a flow of lithography process according to one embodiment;

FIG. 2 is a block diagram schematically showing a lithography system for carrying out the lithography process of the embodiment;

FIG. 3 is a view schematically showing a peripheral exposure apparatus according to one embodiment;

FIG. 4 is a view schematically showing a micro-mirror according to one embodiment;

FIG. 5 is a view schematically showing a state of deficient shot according to one embodiment; and

FIG. 6 is a view for explaining deficient shot.

### DETAILED DESCRIPTION OF THE INVENTION

Hereinafter, embodiments of the present invention will be described with reference to the drawings.

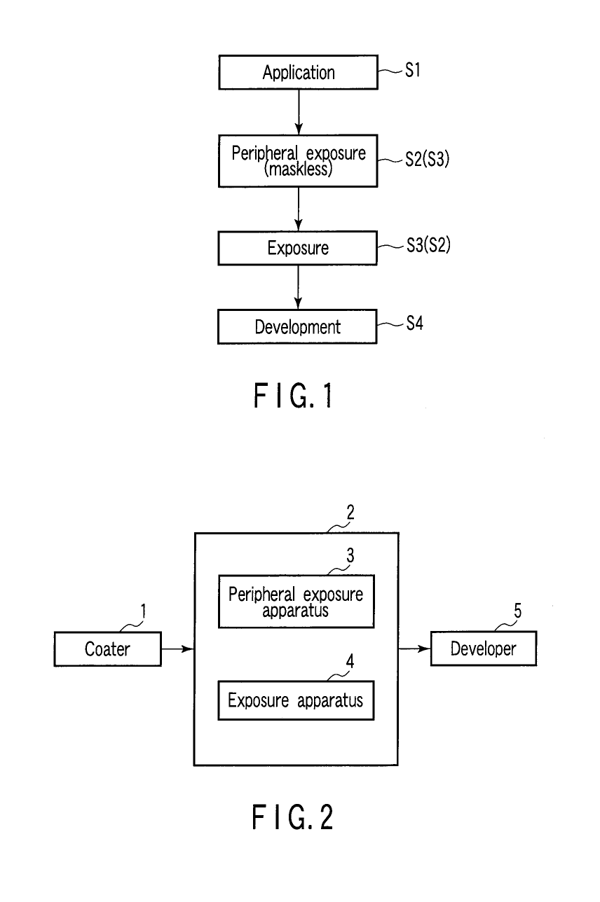

FIG. 1 is a flowchart showing a flow of lithography process according to one embodiment.

[S1]

A resist is applied on a wafer. Thereafter, heat treatment is carried out to harden the resist. Hereinafter, the resist subjected to the heat treatment is called as a resist film.

[S2]

Exposure (peripheral exposure) of the resist film on the wafer peripheral portion is carried out. This peripheral exposure is the deficient shot in which an area protrudes from the wafer is also exposed.

According to the conventional deficient shot, a normal exposure apparatus is used. However, according to the present embodiment, a special exposure apparatus (peripheral exposure apparatus) described later is used to perform the deficient shot.

The peripheral exposure apparatus of the present embodiment makes the deficient shot in maskless manner, and continuously performs a plurality of deficient shots. Thereby, the throughput of the deficient shot (wafer peripheral exposure) increases as compared with the conventional deficient shot using the normal exposure apparatus.

[S3]

The wafer in the peripheral exposure apparatus is moved into a normal exposure apparatus, thereafter, the resist film on an area other than the peripheral areas is exposed using the normal exposure apparatus.

Here, time loss is taken to move the wafer. However, according to the present embodiment, the total throughput of the exposure process increases because the throughput of the deficient shot is high.

[S4]

The exposed resist film is developed to form a resist pattern on the wafer. Thereafter, a known etching process is carried out. According to the present embodiment, throughput of the pattern forming process including lithography and etching processes becomes high because the throughput of the exposure process in the lithography process is high.

In the present embodiment, normal exposure is carried out after the peripheral exposure, the process sequence may be conversed.

FIG. 2 is a block diagram schematically showing the lithography system for carrying out the lithography process of the present embodiment. This lithography system comprises a known coating equipment (coater) 1 (application equipment) for carrying out the step S1, an exposure system 2 for carrying out the step S2, and a known developer 5 (developing equipment) for carrying out the step S3. The coating equipment 1 including baking unit (not shown).

The exposure system 2 includes the peripheral exposure apparatus 3 of the embodiment and a normal exposure apparatus 4. Hereinafter, the peripheral exposure apparatus 3 of the embodiment will be described.

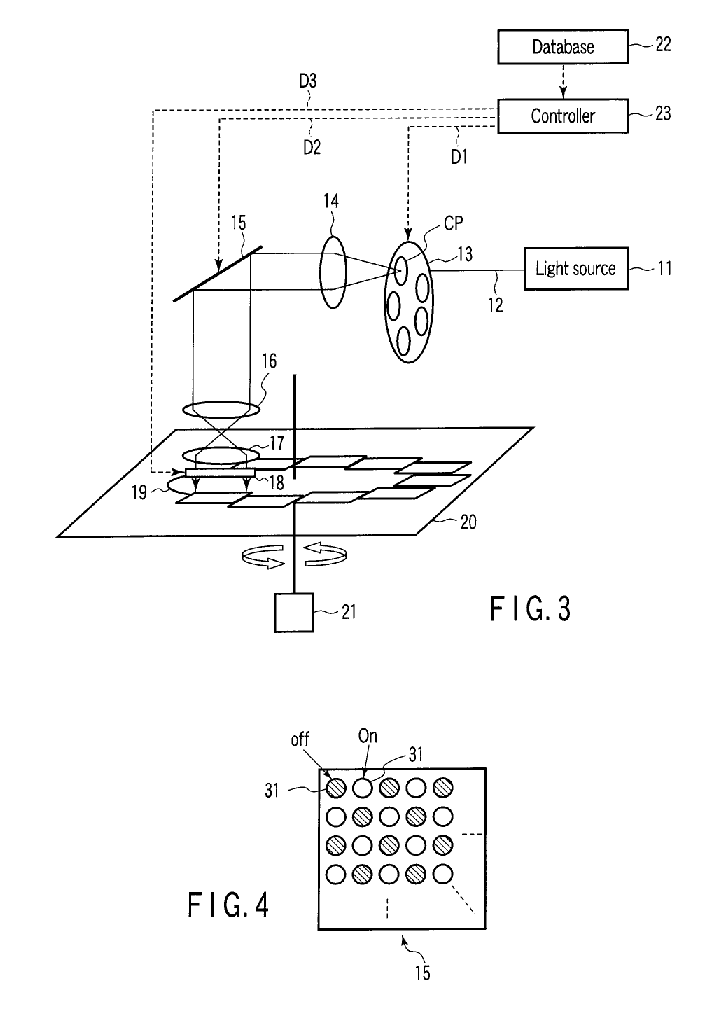

FIG. 3 is a view schematically showing the peripheral exposure apparatus 3.

In FIG. 3, a reference numeral 11 denotes a light source (exposure light source) emitting exposure light, and 12 denotes light emitted from the light source 11, a reference numeral 13 denotes an aperture, 14 denotes a lens, and 15 denotes a micro-mirror, reference numerals 16 and 17 denote lenses, 18 denotes a variable slit, and 19 denote a wafer, a reference numeral 20 denotes a wafer stage, and 21 denotes a wafer stage rotary mechanism, 22 denotes database, a reference numeral 23 denotes a controller for controlling the aperture 13, micro-mirror 15 and variable slit 18.

The light source 11 is an ArF light source, for example,

The aperture 13 includes a plurality of character pattern openings (CP). The plurality of character pattern openings include a plurality of openings whose shapes are the same but the size are mutually different. In addition, a plurality of openings mutually different shape may be included. Square and triangle are given as an example of the shape. The light emitted from the light source 11 is narrowed by passing through the opening.

The lenses 14, 16 are normal glass lenses, for example.

The micro-mirror 15 comprises, for example, the structure shown in FIG. 4, in which a plurality of shutters 31 capable of varying reflectance is arrayed like a matrix.

Each of the shutters 31 takes an on state (high reflectance) or an off state (low reflectance). Thereby, it is possible to vary coverage of light 17 (pattern density of the light 17) on the wafer 19 (resist film).

The on/off state of each shutter is selected so that the coverage of the wafer peripheral portion becomes the same as that of the wafer central portion. Thereby, a pattern density obtained through the deficient shot and the development process and a pattern density obtained through the normal shot which is carried out in the vicinity of the area where the deficient shot is carried out and the development process becomes equal. As a result, the dimensional uniformity in the wafer plane is easily controlled.

An optical filter having a plurality of matrix-like arrayed areas capable of varying transmittance may be used in place of the micro-mirror 15.

The lens 14, micro-mirror 15, lens 16 and lens 17 constitute an image optical system.

The variable slit 18 is provided between the lens 17 and the wafer 19. The variable slit 18 is configured to vary a slit size (aperture size) so that the size of light irradiated onto the wafer 19 is controlled. For example, in a case where the slit (aperture) has a rectangular shape, the size of the light is controlled by varying one of the shorter side and the longer side, or both of the shorter side and the longer side. This is realized using a known variable slit mechanism.

The wafer 19 is a semiconductor wafer such as Si wafer. A resist film is previously formed on the wafer 19. An insulating film, a semiconductor film or metal film may be provided between the semiconductor wafer and the resist film. That is, a part of device may be previously formed on the wafer 19.

The wafer 19 is placed on the wafer stage 20. The wafer stage 20 is rotated by the wafer stage rotary mechanism 21 at a fixed speed during the exposure. Deficient shot is carried out while the wafer stage is rotated at the fixed speed.

The database 22 includes data required for controlling the aperture 13, the micro-mirror 15 and the variable slit 18.

Specifically, the data includes the following data D1 to D3. Data D1 relates to a character pattern (CP) to be selected with respect to the aperture 13. Data D2 relates to on/off (coverage) of each shutter with respect to the micro-mirror 15. Data D3 relates to the slit size with respect to the variable slit 18. The database 22 may includes the same data (a plurality of exposure recipes) as a database used for the normal exposure apparatus. Thus, the database used for the normal exposure apparatus and the database 22 may be collected to one database.

The controller 23 controls the aperture 13, the micro-mirror 15 and the variable slit 18 based on data D1 to D3 from the database 22 so that a plurality of deficient shots is carried out in maskless manner and continuously.

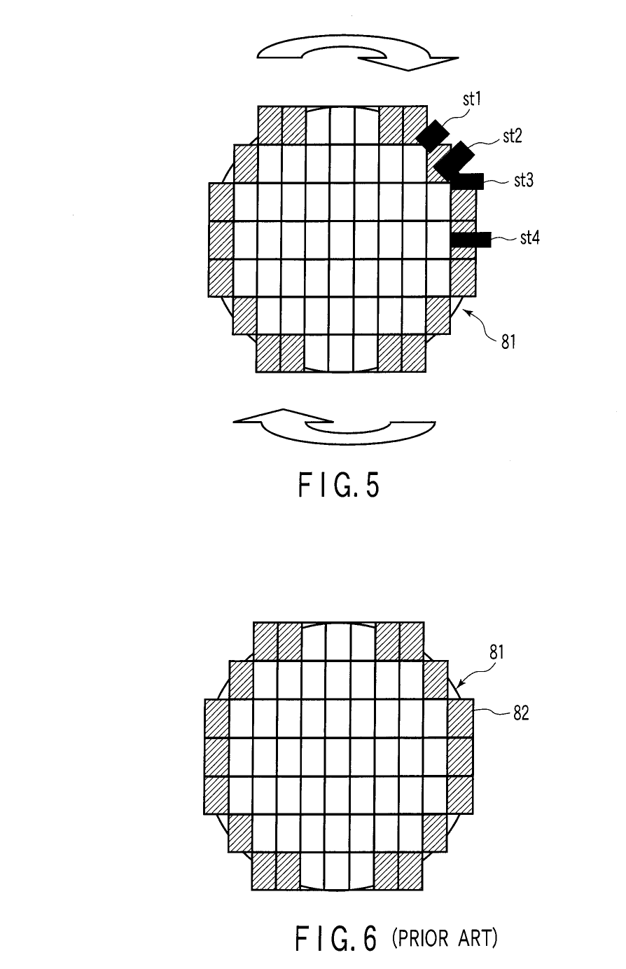

FIG. 5 schematically shows a state of deficient shot. An area where the deficient shot is carried out is shown by slants.

In FIG. 5, st1 schematically shows deficient shot, which selects a first rectangular character pattern CP1, and shortens the dimension of the longer side using the variable slit 18.

In FIG. 5, st2 schematically shows deficient shot, which selects the first rectangular character pattern CP1 without adjusting the dimension using the variable slit 18.

In FIG. 5, st3 schematically shows deficient shot, which selects a second rectangular character pattern CP2, and shortens the dimension of the longer side using the variable slit 18.

In FIG. 5, st4 schematically shows deficient shot, which selects the second rectangular character pattern CP2 without adjusting the dimension using the variable slit 18.

The aperture 13 (selected character pattern) and the variable slit 18 are controlled so that a space (non-exposure area) between neighboring two deficient shots is reduced as much as possible.

The embodiment of the present invention has been described above. However, the present invention is not limited to the embodiment.

For example, according to the embodiment, the aperture 13, the micro-mirror 15 and the variable slit 18 are used, but the throughput is improved as compared with the conventional case even if one or two of the three members is used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An exposure apparatus including a first exposure apparatus used for exposing a peripheral portion of a wafer in maskless manner, the first exposure apparatus comprising:
a light source configured to emit light;
a stage on which the wafer is to be placed; and
a light controller configured to control the light emitted from the light source and irradiated onto a peripheral portion of the wafer placed on the stage, the light controller controlling at least one of shape, size and coverage on the wafer of the light emitted from the light source.

2. The exposure apparatus according to claim 1, wherein the light controller includes
a light aperture unit configured to narrow the light emitted from the light source, and comprising a plurality of openings in which at least one of shape and size are mutually different;
a reflectance/transmittance control unit including an area onto which light passing through the light aperture unit is to be irradiated, and controlling reflectance or transmittance distribution of the light in the area; and
a variable slit unit including a slit configured to change size of light passing through the reflectance/transmittance control unit, and being capable of varying size of the slit.

3. The exposure apparatus according to claim 1, wherein the light aperture unit includes a plurality of character pattern openings.

4. The exposure apparatus according to claim 1, wherein the light aperture unit includes a micro-mirror.

5. The exposure apparatus according to claim 1, further comprises a second exposure apparatus for exposing a portion other than the peripheral portion of the wafer.

6. The exposure apparatus according to claim 2, further comprises a second exposure apparatus for exposing a portion other than the peripheral portion of the wafer.

7. The exposure apparatus according to claim 3, further comprises a second exposure apparatus for exposing a portion other than the peripheral portion of the wafer.

8. The exposure apparatus according to claim 4, further comprises a second exposure apparatus for exposing a portion other than the peripheral portion of the wafer.

9. The exposure apparatus according to claim 1, further comprises a rotary unit configured to rotate the stage.

10. The exposure apparatus according to claim 2, further comprises a rotary unit configured to rotate the stage.

11. The exposure apparatus according to claim 3, further comprises a rotary unit configured to rotate the stage.

12. An exposure method including exposing a peripheral portion of a wafer in maskless manner, comprising: and
controlling at least one of shape, size and coverage on the wafer of the light emitted from the light source, while exposing the peripheral portion of the wafer.

13. The exposure method according to claim 12, further comprises exposing a portion other than the peripheral portion of the wafer.

14. The exposure method according to claim 12, wherein the controlling and the exposing is performed under the wafer is rotating.

15. A lithography system comprising:
an application equipment configured to apply resist on a wafer;
an exposure apparatus configured to expose a peripheral portion and a portion other than the peripheral portion of the resist applied on the wafer by the application equipment, the exposure apparatus including a first exposure apparatus configured to expose the peripheral portion of the resist in maskless manner and a second exposure apparatus configured to expose the portion other than the peripheral portion of the resist, the first exposure apparatus comprising a light source configured to emit light; a stage on which the wafer is to be placed; and a light controller configured to control the light emitted from the light source and irradiated onto the peripheral portion of the wafer placed on the stage, the light controller controlling at least one of shape, size and coverage on the wafer of the light emitted from the light source; and
a developing equipment configured to develop the peripheral portion and the portion other than the peripheral portion of the resist exposed by the exposure apparatus.

16. The lithography system according to claim 15, wherein the light controller includes
a light aperture unit configured to narrow the light emitted from the light source comprising a plurality of openings in which at least one of shape and size are mutually different;
a reflectance/transmittance control unit including an area onto which light passing through the light aperture unit is to be irradiated, and controlling reflectance or transmittance distribution of the light in the area; and
a variable slit unit including a slit configured to change size of light passing through the reflectance/transmittance control unit, and being capable of varying size of the slit.

17. The lithography system according to claim 16, wherein the light aperture unit includes a plurality of character pattern openings.

18. The lithography system according to claim 16, wherein the light aperture unit includes a micro-mirror.

19. The lithography system according to claim 15, further comprises a rotary unit configured to rotate the stage.

20. The lithography system according to claim 16, further comprises a rotary unit configured to rotate the stage.
